(19) United States
(12) Patent Application Publication
(10) Pub. No.: US 2025/0356647 A1
(43) Pub. Date: Nov. 20, 2025

(54) TECHNIQUES FOR IDENTIFYING ENTITIES WITHIN DIGITAL IMAGES USING CONVERSATIONAL INFORMATION ASSOCIATED WITH THE DIGITAL IMAGES

(71) Applicant: Apple Inc., Cupertino, CA (US)

(72) Inventors: Malhar S. JERE, San Francisco, CA (US); Carmel KOZLOV, Weiningen (CH); Muriel NAHMANI, Zurich (CH); Riddhi L. ZUNJARRAO, Zurich (CH); Vinay SHARMA, Palo Alto, CA (US); William M. SIEGRIST, Campbell, CA (US); Alexander MCCAULEY, Woodinville, WA (US); Scott A. JUDY, San Jose, CA (US)

(21) Appl. No.: 19/201,141

(22) Filed: May 7, 2025

Related U.S. Application Data
(60) Provisional application No. 63/647,604, filed on May 14, 2024.

(51) Int. Cl. G06V 10/94; G06F 40/279; G06V 40/10

(52) U.S. Cl. CPC G06V 10/945; G06F 40/279; G06V 40/10

(57) ABSTRACT

A method for identifying entities within digital images using conversational information associated with the digital images is disclosed. The method can include receiving a digital image, through a messaging application, receiving one or more text-based messages through the messaging application within a threshold period of time relative to acquiring the digital image, and generating at least one caption for the digital image. The method can also include analyzing the one or more text-based messages, and the at least one caption, to generate information about a particular entity to which the one or more text-based messages refer, and displaying, within a user interface, at least a portion of the digital image, a description of the particular entity, and a request for input to confirm an association between the particular entity at the digital image.

### CROSS-REFERENCE TO RELATED APPLICATIONS

The present application claims the benefit of U.S. Provisional Application No. 63/647,604, entitled “TECHNIQUES FOR IDENTIFYING ENTITIES WITHIN DIGITAL IMAGES USING CONVERSATIONAL INFORMATION ASSOCIATED WITH THE DIGITAL IMAGES,” filed May 14, 2024, the content of which is incorporated by reference herein in its entirety for all purposes.

### FIELD

The described embodiments relate generally to managing digital images. More particularly, the described embodiments set forth techniques for identifying entities within digital images using conversational information associated with the digital images.

### BACKGROUND

In the realm of personal computing devices, each computing device typically manages a photo album of digital images are taken by, received by, etc., the computing device. As physical cameras have phased out in popularity over the years—and digital camera capabilities, such as digital image resolution and storage capacities, only increase over time—a given photo album typically includes thousands of digital images. In this regard, it can be relatively cumbersome for users to effectively manage their digital images. For example, enabling a given user to efficiently retrieve images featuring a specific individual—such their child—remains imbued with intricacies and hurdles.

One approach for enabling, at least in part, the foregoing functionality involves the process of manually selecting each digital image and then tagging it with relevant metadata indicating the presence of individuals. However, this process can be laborious and prone to errors. Moreover, even with diligently applied tags, the efficacy of subsequent searches hinges heavily upon the consistency and precision under which tagging procedures are/were carried out. Consequently, photo albums typically lack consistent tagging information, which makes it difficult for a user to effectively locate specific digital images.

### SUMMARY

The described embodiments relate generally to managing digital images. More particularly, the described embodiments set forth techniques for identifying entities within digital images using conversational information associated with the digital images.

One embodiment sets forth a method for identifying entities within digital images using conversational information associated with the digital images. According to some embodiments, the method can be implemented by a client computing device, and includes the steps of receiving a digital image, where the digital image is acquired through a messaging application, receiving one or more text-based messages, where the one or more text-based messages is acquired through the messaging application within a threshold period of time relative to acquiring the digital image, generating at least one caption for the digital image, analyzing the one or more text-based messages, and the at least one caption, to generate information about a particular entity to which the one or more text-based messages refer, and displaying, within a user interface: at least a portion of the digital image, a description of the particular entity, and a request for input to confirm an association between the particular entity at the digital image.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIG. 2 illustrates a block diagram that provides an understanding of how the messaging application and the digital image application can function, interact with one another, etc., to identify entities within digital images using conversational information included in messages associated with the digital images, according to some embodiments.

FIG. 3 illustrates a block diagram of a technique for generating digital image captions and digital image vectors based on a digital image, according to some embodiments.

FIGS. 4A-4C illustrate conceptual diagrams of example user interfaces that can be implemented by a messaging application and a digital image application, according to some embodiments.

FIG. 5 illustrates a method for identifying entities within digital images using conversational information associated with the digital images, according to some embodiments.

FIG. 6 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The described embodiments relate generally to managing digital images. More particularly, the described embodiments set forth techniques for identifying entities within digital images using conversational information associated with the digital images.

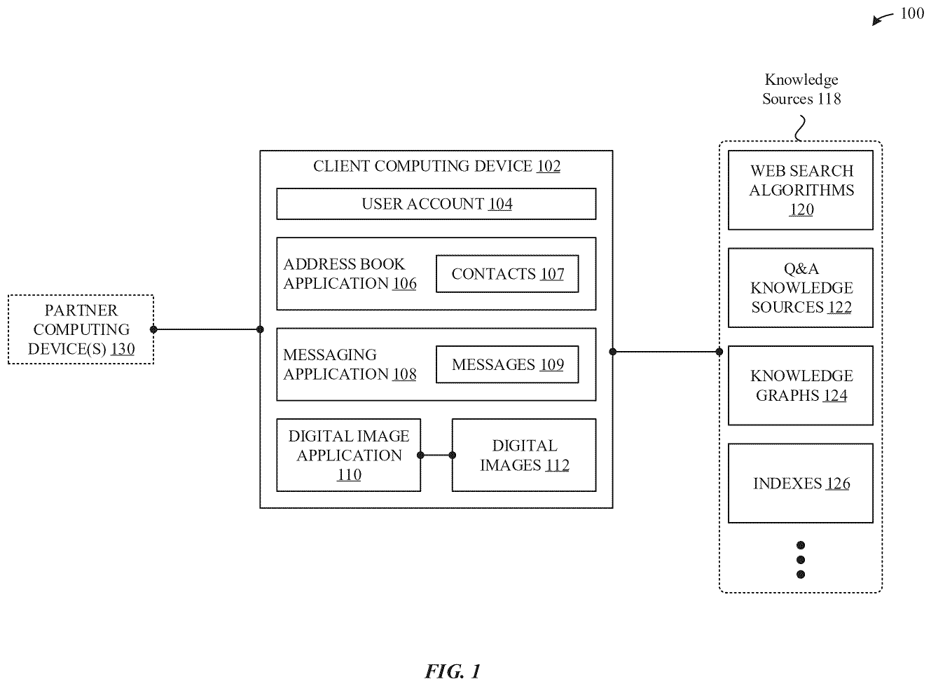

FIG. 1 illustrates a block diagram of different components of a system 100 that can be configured to implement the various techniques described herein, according to some embodiments. As shown in FIG. 1, the system 100 can include a client computing device 102 and, optionally, one or more partner computing devices 130. It is noted that, in the interest of simplifying this disclosure, the client computing device 102 and the partner computing device 130 are typically discussed in singular capacities. In that regard, it should be appreciated that the system 100 can include any number of client computing devices 102 and partner computing devices 130, without departing from the scope of this disclosure.

According to some embodiments, the client computing device 102 and the partner computing device 130 can represent any form of computing device operated by an individual, an entity, etc., such as a wearable computing device, a smartphone computing device, a tablet computing device, a laptop computing device, a desktop computing device, a gaming computing device, a smart home computing device, an Internet of Things (IoT) computing device, a rack mount computing device, and so on. It is noted that the foregoing examples are not meant to be limiting, and that each of the client computing device 102/partner computing device 130 can represent any type, form, etc., of computing device, without departing from the scope of this disclosure.

According to some embodiments, the client computing device 102 can be associated with (i.e., logged into) a user account 104 that is known to the client computing device 102 and the partner computing device 130. For example, the user account 104 can be associated with username/password information, demographic-related information, device-related information (e.g., identifiers of client computing devices 102 associated with the user account 104), and the like.

As shown in FIG. 1, the client computing device 102 can implement an address book application 106 that manages one or more contacts 107. According to some embodiments, each contact 107 can include amount, type, form, etc., of information associated with a given individual, such as a name, a phone number, an email address, a digital image, and so on. According to some embodiments, each contact 107 can be created on the client computing device 102, received from another computing device, and so on.

As shown in FIG. 1, the client computing device 102 can implement a messaging application 108. The messaging application 108 can represent, for example, any application that enables users to transmit messages 109 between one another, the messages 109 can include text, animations, digital media items (e.g., audio files, images, videos, etc.), and the like. For example, the messaging application 108 can represent iMessage® by Apple®. It is noted that the foregoing example is not meant to be limiting, and that the messaging application 108 can represent any software application that facilitates any type, form, etc., of messaging, consistent with the scope of this disclosure. For example, although the techniques described herein primarily focus on conversational messaging between users, the techniques can also be applied to email messaging between users, consistent with the scope of this disclosure.

According to some embodiments, the client computing device 102 can implement a digital image application 110. The digital image application 110 can represent, for example, any application that can manage digital images 112 that are acquired by, for example, a camera application installed on the client computing device 102, the messaging application 108, and so on. The digital images 112 can be stored on, for example, one or more local storage devices, one or more network storage devices, one or more cloud-based storages, etc. According to some embodiments, each digital image 112 can be associated with different types of information, such as metadata of the digital image 112, content of the digital image 112, and the like.

According to some embodiments, the digital image application 110 can implement one or more artificial intelligence (AI) models, such as small language models (SLMs), large language models (LLMs), rule-based models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and the like. It is noted that the foregoing examples are not meant to be limiting, and that any number, type, form, etc., of AI models can be implemented by any of the entities illustrated in FIG. 1, without departing from the scope of this disclosure. Additionally, it should be appreciated that the digital image application 110 can implement non-AI-based entities, such as rules-based systems, knowledge-based systems, and so on.

Accordingly, the digital image application 110 can be configured to generate/maintain caption information for digital images 112. In particular, the digital image application 110 can be configured to implement one or more image captioning models that receive a digital image 112 as input, and then output digital image captions—e.g., text-based information—that describes the digital image 112. In this manner, and described in greater detail herein, the digital image captions can enhance the overall accuracy by which the digital image application 110 identifies connections between entities and digital images 112 and tags the digital images 112 with information.

Additionally, the digital image 112 can be configured to implement one or more image vectorization models that receive a digital image 112 as input, and then output a corresponding digital image vector that captures features of the digital image 112 (e.g., pixel data, spatial information, feature representations, semantic information, contextual understanding, etc.). In doing so, the digital image application 110 can utilize the digital image vectors to identify digital images 112 that share commonalities, such as two or more digital images 112 in which the same entity (e.g., a person, an animal, a place, a thing, etc.) is captured. In this manner, and as described in greater detail herein, when a given digital image 112 is tagged with information (e.g., an identity of a person included in the digital image 112), the digital image application 110 can utilize the digital image vectors to identify other digital images 112 that should potentially be tagged with the same information.

As a brief aside, it should be noted that the embodiments/examples described herein primarily focus on faces of pets, persons, etc., in the interest of unifying this disclosure. However, these embodiments/examples should not be construed as limiting. To the contrary, the techniques described herein can focus on, encompass, consider, etc., any number of characteristics (at any level of granularity) of any object (living, non-living, etc.), consistent with the scope of this disclosure.

According to some embodiments, the digital image application 110 can implement a similarity analyzer that can effectively compare two or more digital image vectors. In particular, the similarity analyzer can implement algorithms that compare the similarities between the aforementioned digital image vectors, generate similarity scores that represent/coincide with the similarities, and so on. The algorithms can include, for example, Cosine Similarity, Euclidean Distance, Manhattan Distance (L1 norm), Jaccard Similarity, Hamming Distance, Pearson Correlation Coefficient, Spearman Rank Correlation, Minkowski Distance, Kullback-Leibler Divergence (KL Divergence), etc., algorithms. It is noted that the foregoing examples are not meant to be limiting, and that the similarity analyzer can implement any number, type, form, etc., of similarity analysis algorithms, at any level of granularity, consistent with the scope of this disclosure.

As a brief aside, it is noted that the client computing device 102 can be configured to identify and eliminate “AI hallucinations,” which refer to the generation of false or distorted perceptions, ideas, or sensations by AI systems. This phenomenon can occur when AI models, such as LLMs, generate outputs that are not based on real data but instead originate from patterns or noise present in their training data or model architecture. Such hallucinations can manifest as incorrect information, fantastical scenarios, nonsensical sentences, or a blend of real and fabricated content.

Additionally, and according to some embodiments, the digital image application 110 can be configured to implement an explanation agent. According to some embodiments, the explanation agent can be configured to implement any number, type, form, etc., of AI models to provide explanations for the various features that are implemented by the digital image application 110. To implement this functionality, the explanation agent can analyze any amount of information, at any level of granularity. In one example, when asking whether a digital image 112 captures a particular entity, the digital image application 110 can include an explanation that the digital image 112 was obtained from the messaging application 108, an explanation about the messages 109 that surrounded the digital image 112 within the messaging application 108 (and that presumably provide relevant context to the digital image 112), an explanation about other digital images 112 that presumably also capture the particular entity, and so on. It is noted that the foregoing examples are not meant to be limiting, and that the explanations can include any amount, type, form, etc., of information, at any level of granularity, without departing from the scope of this disclosure.

Additionally, it is noted that, under some configurations, the explanation agent can also be configured to provide explanations for digital images 112 that were filtered out by the digital image 112 (e.g., when attempting to identify other digital images 112 that capture the same individual). In turn, such explanations can be utilized in any manner to improve the manner in which the system 100 functions. For example, the explanations can be used to improve the intelligence of the various AI models discussed herein, to demonstrate to end-users that time is being saved by intelligently eliminating certain results for good/explainable reasons, and so on.

Additionally, and according to some embodiments, the digital image application 110 can be configured to implement one or more generative AI engines (not illustrated in FIG. 1) to generate content that is relevant to the techniques described herein. For example, the content agent can implement generative adversarial networks (GANs), variational autoencoders (VAEs), recurrent neural networks (RNNs), convolutional neural networks (CNNs), neuroevolution systems, deep dream systems, style transfer systems, rule-based systems, interactive evolutionary algorithms, and so on. Such content can include, for example, digital content (e.g., text content, image content, audio content, video content, etc.) that corresponds to the digital images 112, identified entities, and so on. It is noted that the foregoing examples are not meant to be limiting, and that the content agent can generate any amount, type, form, etc., of digital content, at any level of granularity, without departing from the scope of this disclosure. For example, the content can include audio content, video content, document content, web content (e.g., hypertext markup language (HTML) content), programming language content, and so on.

As further shown in FIG. 1, the client computing device 102—particularly, the various entities implemented thereon (e.g., the messaging application 108, the digital image application 110, etc.)—can optionally be configured to implement, interface with, etc., knowledge sources 118, to expand on the features described herein. According to some embodiments, the knowledge sources 118 can include, for example, web search algorithms 120, question and answer (Q&A) knowledge sources 122, knowledge graphs 124, indexes 126 (e.g., databases, approximate nearest-neighbor (ANN) indexes, inverted indexes, etc.), and so on.

According to some embodiments, the web search algorithms 120 can represent web search entities that are capable of receiving queries and providing answers based on what is accessible via the Internet. To implement this functionality, the web search algorithms 120 can “crawl” the Internet, which involves identifying, parsing, and indexing the content of web pages, such that relevant content can be efficiently identified for queries that are received.

According to some embodiments, the Q&A knowledge sources 122 can represent systems, databases, etc., that can formulate answers to questions that are commonly received. To implement this functionality, the Q&A knowledge sources 122 typically rely on structured or semi-structured knowledge bases that contain a wide range of information, facts, data, or textual content that is manually curated, generated from text corpora, or collected from various sources, such as books, articles, databases, or the Internet.

According to some embodiments, the knowledge graphs 124 can represent systems, databases, etc., that can be accessed to formulate answers to queries that are received. A given knowledge graph 124 typically constitutes a structured representation of knowledge that captures relationships and connections between entities, concepts, data points, etc. in a way that computing devices are capable of understanding.

According to some embodiments, the indexes 126 can represent systems, databases, etc., that can be accessed to formulate answers to queries that are received. For example, the indexes 126 can include an ANN index that constitutes a data structure that is arranged in a manner that enables similarity searches and retrievals in high-dimensional spaces to be efficiently performed. This makes the ANN indexes particularly useful when performing tasks that involve semantic information retrieval, recommendations, and finding similar data points, objects, and so on.

It is noted that the knowledge sources 118 illustrated in FIG. 1 and described herein are not meant to be limiting, and that the entities implemented on the client computing device 102 can be configured to access any type, kind, form, etc., of knowledge source 118 that is capable of receiving queries and providing responses, without departing from the scope of this disclosure. It should also be appreciated that the knowledge sources 118 can employ any number, type, form, etc., of AI models (or non-AI based approaches) to provide the various functionalities described herein, without departing from the scope of this disclosure. It should also be understood that the knowledge sources 118 can be implemented by any computing entity (e.g., the client computing device 102, the partner computing device 130, etc.), service (e.g., cloud service providers), etc., without departing from the scope of this disclosure (depending on, e.g., privacy settings that are enforced by the client computing device 102). It should be appreciated that when knowledge sources 118 are external to and utilized by the client computing device 102, the relevant information described herein can be filtered, anonymized, etc., in order to reduce/eliminate sensitive information that could otherwise be gleaned from the relevant information.

It is noted that the logical breakdown of the entities illustrated in FIG. 1—as well as the logical flow of the manner in which such entities communicate—should not be construed as limiting. On the contrary, any of the entities illustrated in FIG. 1 can be separated into additional entities within the system 100, combined together within the system 100, removed from the system 100, etc., without departing from the scope of this disclosure. It is additionally noted that, in the interest of unifying and simplifying this disclosure, the described embodiments primarily discuss digital images 112. However, it should be appreciated that the embodiments disclosed herein can be applied to other types of digital assets—e.g., audio files, video files, etc.—consistent with the scope of this disclosure.

Additionally, it should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

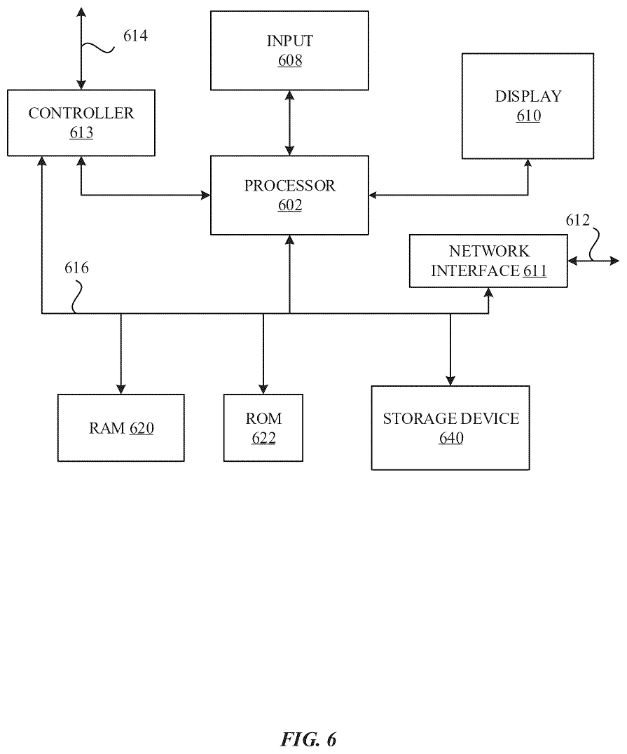

A more detailed explanation of these hardware components is provided below in conjunction with FIG. 6. It should additionally be understood that the computing devices can include other entities that enable the implementation of the various techniques described herein, without departing from the scope of this disclosure. It should additionally be understood that the entities described herein can be combined or split into additional entities, without departing from the scope of this disclosure. It should further be understood that the various entities described herein can be implemented using software-based or hardware-based approaches, without departing from the scope of this disclosure.

It is noted that the techniques described herein can be performed entirely on the client computing device 102. It should be appreciated that this configuration provides enhanced privacy features in that messages 109, digital images 112, etc., are locally-processed on the client computing device 102. This approach can reduce some of the privacy risks that may be inherent when transferring the foregoing information elsewhere for processing (e.g., one or more partner computing devices 130), although overall processing latencies and battery life preservation can present challenges due the inherently limited hardware characteristics of the client computing device 102 (relative to the partner computing devices 130). In this regard, it should be appreciated that the client computing device 102 can interface with other entities—such as one or more partner computing devices 130—to implement all or a portion of the features described herein. However, this approach can increase some of the privacy risks that may be inherent when transferring the foregoing information elsewhere for processing, although the aforementioned processing latencies and battery life preservation concerns can be mitigated due to the enhanced hardware characteristics of the partner computing devices 130 (relative to the client computing device 102). In the interest of simplifying this disclosure, the primarily-discussed embodiments utilize an on-device approach, i.e., where the client computing device 102 implements the techniques with no involvement from external entities such as partner computing devices 130.

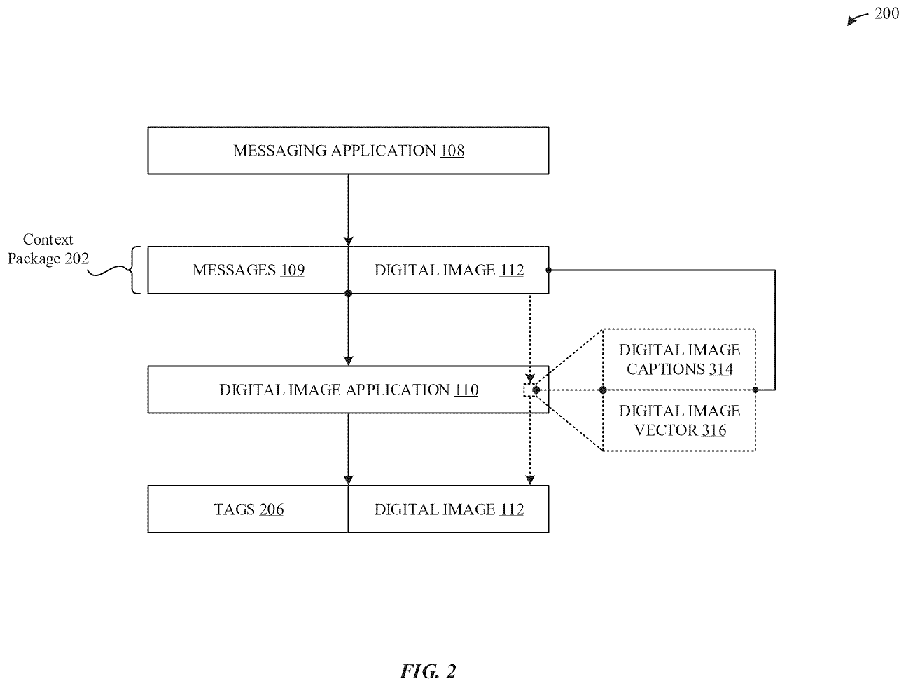

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2-6.

FIG. 2 illustrates a block diagram 200 that provides an understanding of how the messaging application 108 and the digital image application 110 can function, interact with one another, etc., to identify entities within digital images 112 using conversational information included in messages 109 associated with the digital images 112, according to some embodiments. As shown in FIG. 2, the messaging application 108 can provide a context package 202 to the digital image application 110 when one or more conditions are satisfied. For example, the context package 202 can be provided when (1) a digital image 112 is transmitted between two or more individuals communicating through the messaging application 108, (2) a threshold number of messages 109 precede and/or succeed the digital image 112, and (3) the messages 109 are transmitted within a threshold amount of time relative to transmitting the digital image 112. Under one approach, the context package 202 can be provided when the foregoing conditions are satisfied. Under another approach, the context package 202 can be provided at times when the client computing device 102 is not being actively utilized. It is noted that the foregoing examples are not meant to be limiting, and that the messaging application 108 can be configured to provide context packages 202 to the digital image application 110 in response to any number, type, form, etc., of condition(s) being satisfied, at any level of granularity, consistent with the scope of this disclosure.

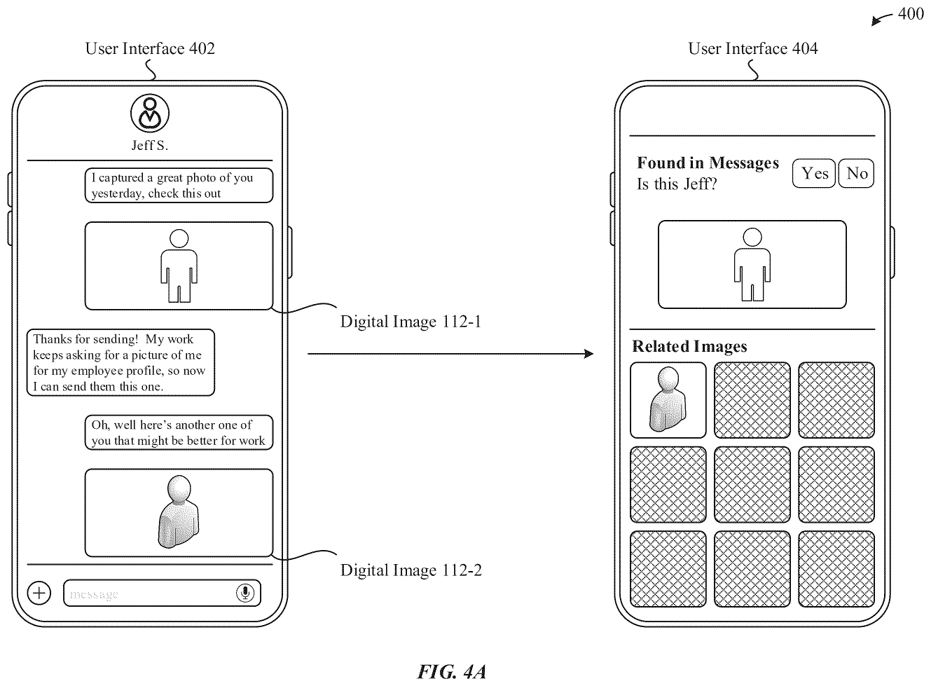

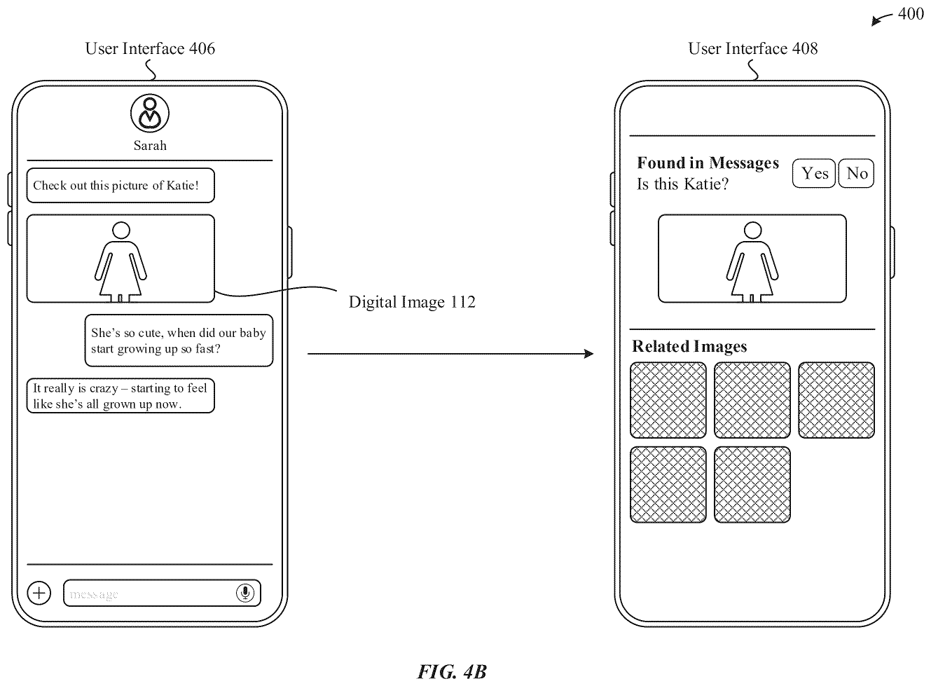

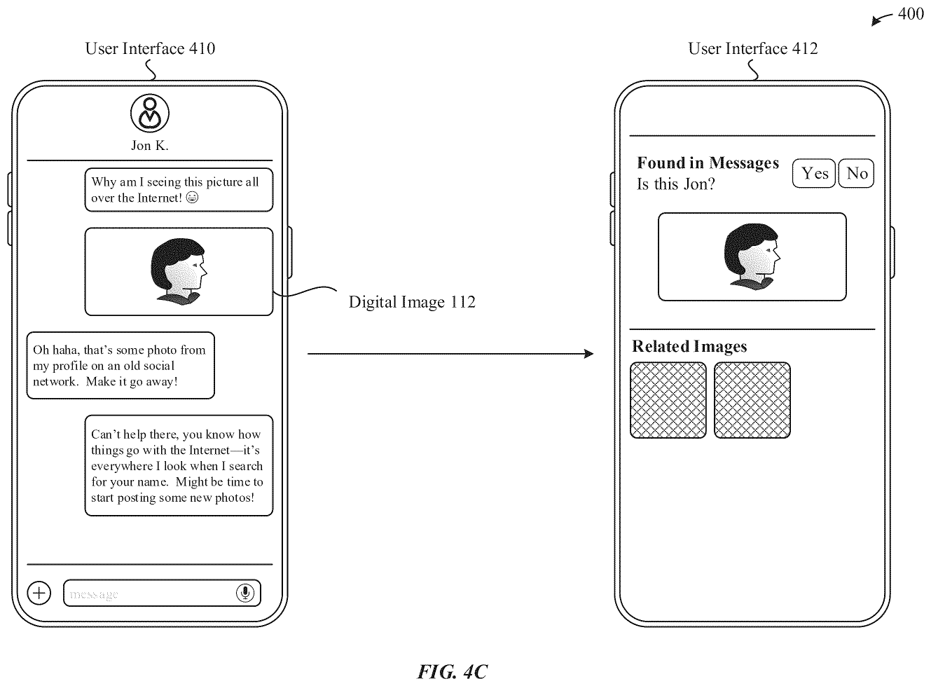

As shown in FIG. 2, the context package 202 can include (1) the aforementioned digital image 112, and (2) the aforementioned messages 109. FIGS. 4A-4C illustrate different example messaging scenarios 400 that would result in context packages 202 being provided from the messaging application 108 to the digital image application 110, according to some embodiments. In particular, FIG. 4A illustrates a first example scenario, where a user interface 402 of the messaging application 108 includes example messages between a user (e.g., “Carl”, the person operating the client computing device 102/messaging application 108) and an individual named “Jeff S.”. In this scenario, a first message 109 (“I captured a great . . . ”) is transmitted by Carl to Jeff, followed by a digital image 112-1 that is transmitted by Carl to Jeff. In turn, Jeff replies to Carl with the message 109 (“Thanks for sending! . . . ”). Here, the messaging application 108 can be configured to provide a first context package 202 that includes (1) the digital image 112-1, and (2) the aforementioned first and second messages 109 between Carl and Jeff. Additionally, and as shown in FIG. 4A, Carl transmits an additional message 109 (“Oh, well here's . . . ”) to Jeff, as well as an additional digital image 112-2. In this regard, the messaging application 108 can be configured to provide a second context package 202 that includes (1) the digital image 112-2, and (2) the aforementioned additional message 109.

FIG. 4B illustrates a second example scenario, where a user interface 406 of the messaging application 108 includes example messages between a user (e.g., “Carl”, the person operating the client computing device 102/messaging application 108) and “Sarah” (Carl's wife). In this scenario, a first message 109 (“Check out this picture . . . ”) is transmitted by Sarah to Carl, followed by a digital image 112 that is transmitted by Sarah to Carl. In turn, Carl replies to Sarah with the message 109 (“She's so cute . . . ”), and Sarah replies to Carl with the message 109 (“It really is crazy . . . ”). Here, the messaging application 108 can be configured to provide a context package 202 that includes (1) the digital image 112, and (2) the aforementioned messages 109 between Sarah and Carl.

FIG. 4C illustrates a third example scenario, where a user interface 410 of the messaging application 108 includes example messages between a user (e.g., “Carl”, the person operating the client computing device 102/messaging application 108) and “Jon K.”. In this scenario, a first message 109 (“Why am I seeing . . . ”) is transmitted by Carl to Jon, followed by a digital image 112 that is transmitted by Carl to Jon. In turn, Jon replies to Carl with the message 109 (“Oh haha, that's some . . . ”), and Carl replies to Jon with the message 109 (“Can't help you there . . . ”). Here, the messaging application 108 can be configured to provide a context package 202 that includes (1) the digital image 112, and (2) the aforementioned messages 109 between Carl and Jon.

Accordingly, different interactions between users—as well as different operational configurations implemented by the messaging application 108 (that describe, for example, conditions under which context packages 202 are to be provided)—can result in context packages 202 being provided by the messaging application 108 to the digital image application 110. It is noted that the examples illustrated in FIGS. 4A-4C are not meant to be limiting. For example, a configuration of the messaging application 108 can be adjusted at any level of granularity to modify how and when context packages 202 are to be assembled, provided to the digital image application 110, and so on, consistent with the scope of this disclosure.

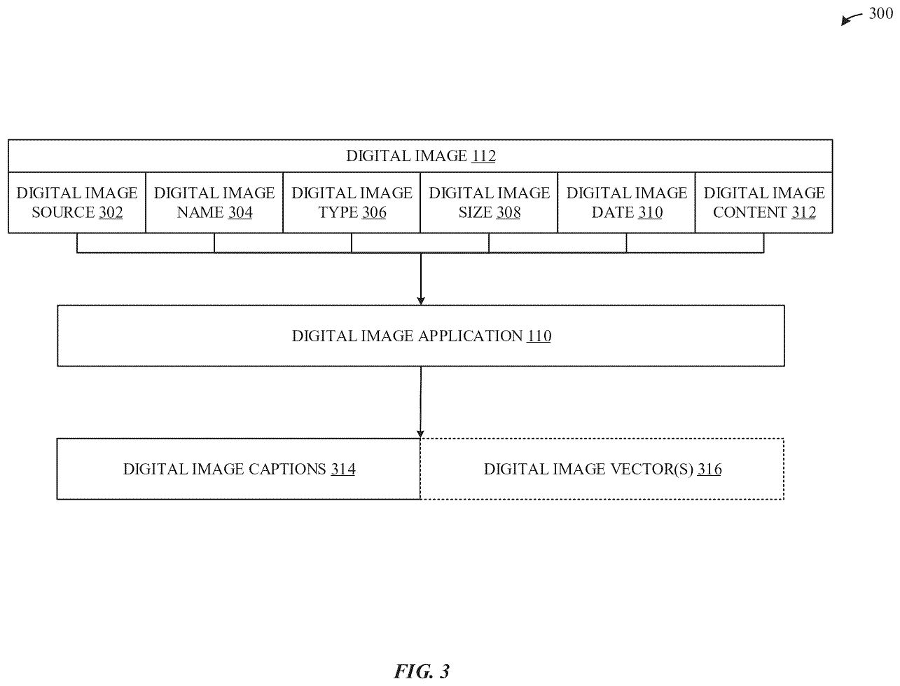

Returning now to FIG. 2, when the digital image application 110 receives a context package 202 from the messaging application 108, the digital image application 110 can be configured to generate (1) digital image captions 314 for the digital image 112, and, optionally, (2) a digital image vector 316 for the digital image 112. As previously described herein—and as shown in FIGS. 2-3—the digital image application 110 can be configured to generate the digital image captions 314 using at least one image caption model that receives the digital image 112 as input and outputs at least one digital image caption 314 for the digital image 112. As described below in conjunction with FIG. 3, the digital image application 110 can also generate the digital image captions 314 based on metadata (and/or other information) associated with the digital image 112. The digital image captions 314 can describe, for example, objects, activities, attributes, scene, emotions, interactions, location, time, abstract concepts, contextual details, etc., associated with the digital image 112. For example, if a digital image 112 captures a baby sitting on the beach, then the digital image captions 314 could include “baby, infant, beach, sunny, sand, toys, bathing suit, hat, water, smile, California” (where such characteristics are presumably associated with the digital image 112). It is noted that the foregoing examples are not meant to be limiting, and that the digital image captions 314 can include any amount, type, form, etc., of information, at any level of granularity, consistent with the scope of this disclosure.

As previously described herein, and as shown in FIGS. 2-3—the digital image application 110 can optionally be configured to generate one or more digital image vectors 316 for the digital image 112. According to some embodiments, the vectors described herein can represent foundational embeddings (i.e., vectors) that are stable in nature. As a brief aside, in the realm of artificial intelligence (AI) and machine learning, the generation of stable vectors for data can utilized to implement effective model training and inference. Generating stable vectors involves a systematic approach that can begin with data pre-processing, where raw data undergoes cleaning procedures to address missing values, outliers, and inconsistencies. Numerical features can be standardized or normalized to establish a uniform scale, while categorical variables can be encoded into numerical representations through techniques such as one-hot encoding or label encoding. Feature engineering can be employed to identify and create relevant features that enhance the model's capacity to discern patterns within the data. Additionally, for text data, tokenization can be employed to break down the text into constituent words or sub-word units, which can then be converted into numerical vectors using methodologies like word embeddings.

The aforementioned vectorization processes can be used to amalgamate all features into a unified vector representation. Careful consideration can be given to normalization to ensure stability across different feature scales. Additional considerations can involve the handling of sequential data through techniques such as recurrent neural networks (RNNs) and transformers, as well as dimensionality reduction methods such as Principal Component Analysis (PCA) or t-distributed Stochastic Neighbor Embedding (t-SNE). Embedding layers may also be applied for certain data types, and consistency throughout the vector generation process can be maintained to uphold stability in both training and inference phases. Moreover, thorough testing and validation on a separate dataset can help confirm that the generated vectors effectively encapsulate pertinent information and patterns within the data. This comprehensive approach can help ensure the reliability and stability of any AI system's overall performance, accuracy, and the like.

Additionally, it is noted that the various entities described herein—such as the AI models implemented by the digital image application 110—can undergo training using query-item pairs. In particular, positive samples can be derived from search logs, while negative samples can be randomly selected from both the digital images 112 and the search logs. Moreover, incorporating log-based negative sampling can help prevent the models from favoring popular results consistently, as such results are prone to occur more frequently in the training data. In this regard, the embodiments effectively exercise contrastive learning, which can obviate the necessity for a balanced distribution of positive and negative samples.

It is noted that the foregoing description of AI-based approaches is not meant to be limiting, and that any number, type, form, etc., of AI-based (and/or non-AI-based) approaches can be utilized, at any level of granularity, to implement the techniques described herein, consistent with the scope of this disclosure.

Returning now to FIG. 3, a digital image vector 316 for a digital image 112 can be generated by the digital image application 110 (e.g., at the time the digital images 112 are created, acquired, etc., at a time subsequent to the creation, acquisition, etc., of the digital images 112, etc.). The block diagram 300 of FIG. 3 provides examples of different aspects, characteristics, etc., of a given digital image 112 that can be considered when generating the digital image vector 316 for the digital image 112, according to some embodiments.

In one example approach, metadata associated with the digital image 112 can include a source from which the digital image 112 was created, acquired, etc., (e.g., an identifier of the messaging application 108, a name of an individual, contact, etc., who provided digital image 112 (e.g., via the messaging application 108), etc.), which is illustrated in FIG. 3 as the digital image source 302. The metadata can also include a name of the digital image 112 (e.g., a filename, a nickname, etc.), which is illustrated in FIG. 3 as the digital image name 304. The metadata can also include a type of the digital image 112 (e.g., a file type, extension, etc.), which is illustrated in FIG. 3 as the digital image type 306. The metadata can also include a size of the digital image 112 (e.g., file size information, dimension information, etc.), which is illustrated in FIG. 3 as the digital image size 308. The metadata can also include a date associated with the digital image 112 (e.g., a creation date, access dates, etc.), which is illustrated in FIG. 3 as the digital image date 310. It is noted that the different properties of the digital image 112 illustrated in FIG. 3 are not meant to be limiting, and that any amount, type, form, etc., of information associated with the digital image 112, at any level of granularity, can be considered when analyzing digital image metadata, consistent with the scope of this disclosure.

Additionally, it should be appreciated that different properties can be considered, analyzed, etc., depending on the nature of the digital image 112 for which the digital image vector 316 is being generated. For example, the properties can include the resolution, format, metadata, color space, bit depth, compression, layers (for layered formats like PSD), histogram, alpha channel (for transparent images), embedded color profile, location, and so on, of the digital image 112. It is noted that the foregoing examples are not meant to be limiting, and that the properties of a given digital image 112 can include any amount, type, form, etc., of property/properties of the digital image 112, at any level of granularity, consistent with the scope of this disclosure. It should also be appreciated that a respective rule set can be established for each type of digital image 112 so that the relevant information can be gathered from the digital image 112 and processed.

According to some embodiments, and as shown in FIG. 3, the digital image source 302, digital image name 304, digital image type 306, digital image size 308, and digital image date 310 can be considered when generating the digital image vector 316. This information can also be considered when generated the digital image captions 314. According to some embodiments, the digital image application 110 can implement any number of approaches for effectively generating the digital image vector 316 based on the digital images 112, information associated therewith, etc. For example, the digital image application 110 can implement one or more transformer-based LLMs that are specifically tuned to work with the types of inputs they receive. For example, the digital image application 110 can implement the same or similar small-token LLMs for text inputs (i.e., source, name, type, size, date) that are relatively small. Similarly, the digital image application 110—which, as described below, receives larger inputs (i.e., digital image content 312 of the digital image 112)—can implement a large-token LLM that is specifically designed to manage larger inputs, one or more pooling engines to pool segmented portions of the content (e.g., that have been vectorized by one or more LLMs), and so on.

Additionally, and as shown in FIG. 3, the digital image vector 316 can be based on the actual content of the digital image 112 (illustrated in FIG. 3 as digital image content 312). According to some embodiments, the digital image content 312 can be pre-processed using any number, type, form, etc., of operation(s), at any level of granularity, prior to generating the digital image vector(s) 316. According to some embodiments, the digital image application 110 can implement any number of approaches for generating the digital image vector 316 based on the digital image content 312. For example, the digital image application 110 can implement a machine learning model—such as a digital image model—that generates the digital image vector 316 at least in part on the content of the digital image 112. The digital image model can be configured to perform, for example, object recognition, scene understanding, semantic segmentation, object localization, image classification, text recognition (OCR), contextual understanding, geo-tagging, visual similarity, emotion recognition, etc., techniques on the content of the digital image 112. It is noted that the foregoing examples are not meant to be limiting, and that the digital image vector 316 can be based on any amount, type, form, etc., of characteristics of the digital image 112, at any level of granularity, consistent with the scope of this disclosure. It is also noted that the foregoing examples are not meant to be limiting, and that the digital image application 110 can be configured to implement any amount, type, form, etc., of AI-based/non-AI-based approaches, at any level of granularity, to establish the digital image vector 316 for a given digital image 112, consistent with the scope of this disclosure.

Accordingly, FIG. 3 illustrates an example approach for establishing, maintaining, etc., one or more digital image captions 314, and one or more digital image vectors 316, that correspond to a digital image 112. It should be understood that the approaches illustrated in FIG. 3 are not meant to be limiting in any way, and that other, additional, etc., aspects, characteristics, etc., of/associated with the digital image 112 (and/or other information) can be utilized to form the digital image vector 316, consistent with the scope of this disclosure.

Returning now to FIG. 2, the digital image application 110 can, in conjunction with obtaining digital image captions 314 and digital image vectors 316 for the digital image 112, attempt to establish one or more tags 206 for the digital image 112, where each tag 206 corresponds to an entity (e.g., a person, an animal, a place, a thing, etc.) that is associated with, captured within, etc., the digital image 112. According to some embodiments, the digital image application 110 provides, to one or more artificial intelligence/machine learning (AI/ML) models, the digital image 112, the messages 109, the digital image captions 314, the digital image vectors 316, and so on, to effectively identify at least one entity that, at least to a threshold degree of confidence, is included in the digital image 112.

By way of example, consider the scenario illustrated in FIG. 4A. When the first context package 202 (associated with the digital image 112-1) is processed, the digital image application 110 can identify that Carl, by stating “you” in the message 109, is referring to Jeff. The digital image application 110 can also identify that Jeff, by stating to Carl in the message 109, “picture of me”, is referring to himself (Jeff). Based on these identifications—along with the temporal/sequential proximity of the aforementioned messages 109 relative to the digital image 112-1, as well as the information available from the digital image 112, the digital image captions 314, the digital image vectors 316, etc.—the digital image application 110 can conclude, at least with a reasonable level of confidence, that Jeff is captured in the digital image 112-1. Similarly, when the second context package 202 (associated with the digital image 112-2 is processed), the digital image application 110 can identify that Carl, by stating to Jeff in the message 109, “another one of you”, is referring to Jeff. Based on this identification—along with the temporal/sequential proximity of the aforementioned message 109 relative to the digital image 112-2, as well as the information available from the digital image 112, the digital image captions 314, the digital image vectors 316, etc.—the digital image application 110 can conclude, at least with a reasonable level of confidence, that Jeff is captured in the digital image 112-2. In turn, the digital image application 110 can present a user interface 404 that displays the digital image 112-1 and the digital image 112-2 (as well as any other digital images 112 that relate to Jeff (e.g., by way of the digital image vectors 316 described herein)), as well as a request to confirm whether the digital images 112 correspond to Jeff.

By way of another example, consider the scenario illustrated in FIG. 4B. When the context package 202 (associated with the digital image 112) is processed, the digital image application 110 can identify that Sarah, by stating “Katie”, is referring to Katie. The digital image application 110 can also identify that Carl, by stating to Katie, “She's so cute, when did our baby start growing up so fast”, is referring to the digital image 112 of Katie that was provided by Sarah. The digital image application 110 can also identify that Sarah and Carl are the parents of Katie. Based on these identifications—along with the temporal/sequential proximity of the aforementioned messages 109 relative to the digital image 112, as well as the information available from the digital image 112, the digital image captions 314, the digital image vectors 316, etc.—the digital image application 110 can conclude, at least with a reasonable level of confidence, that Katie is captured in the digital image 112. In turn, the digital image application 110 can present a user interface 408 that displays the digital image 112 (as well as any other digital images 112 that relate to Jeff (e.g., by way of the digital image vectors 316 described herein)), as well as a request to confirm whether the digital image 112 corresponds to Katie.

As previously described herein, in some cases, the digital image application 110 can identify different relationships that exist between different individuals, such as the relationships between Katie (daughter), Carl (father), and Sarah (mother) described above in conjunction with FIG. 4B. In this regard, additional associations can be made to enable valuable features to be provided. For example, when “Katie” is associated with the digital image 112 in FIG. 4B, “daughter” can also be associated with the digital image 112. In this manner, Carl can simply search for “Katie” or “daughter” to retrieve digital images 112 associated with Katie, his daughter. In another example, when “Katie” is associated with the digital image 112 in FIG. 4B, information can be relayed between Carl and Sarah (e.g., by way of cloud services accessible to the user accounts 104 associated with Carl and Sarah), such that the same associations are assigned, available, etc., on Sarah's client computing device 102. It is noted that the foregoing examples are not meant to be limiting, and that the assignments can be shared across any number of user accounts 104, client computing devices 102, etc., at any level of granularity, consistent with the scope of this disclosure.

By way of another example, consider the scenario illustrated in FIG. 4C. When the context package 202 (associated with the digital image 112) is processed, the digital image application 110 attempts to parse the message 109 (“Why am I seeing this . . . ”). However, this message 109 does not include any names, pronouns, etc., so the digital image application 110 is unable to conclude—at least not to a reliable degree—whether the digital image 112 corresponds to Carl, Jon, or some other entity. Accordingly, the digital image application 110 processes the message 109, “photo from my profile”, stated by Jon, which enables the digital image application 110 to identify that the digital image 112 likely corresponds to Jon. The message 109 “Can't help there . . . ” can also provide additional context that enables the digital image application 110 to conclude, at least to a reliable degree, that the digital image 112 captures Jon. Based on these identifications—along with the temporal/sequential proximity of the aforementioned messages 109 relative to the digital image 112, as well as the information available from the digital image 112, the digital image captions 314, the digital image vectors 316, etc.—the digital image application 110 can conclude, at least with a reasonable level of confidence, that Jon is captured in the digital image 112. In turn, the digital image application 110 can present a user interface 412 that displays the digital image 112 (as well as any other digital images 112 that relate to Jeff (e.g., by way of the digital image vectors 316 described herein)), as well as a request to confirm whether the digital image 112 corresponds to Jon.

In the examples illustrated in FIGS. 4A-4C, the user interface 404, user interface 408, and user interface 412 enable a user of the client computing device 102 to confirm or deny the presumed associations that the digital image application 110 has identified between the digital images 112 and the named entities. When the user confirms a given association, the digital image application 110 can associate the name of the entity to the digital image 112 by way of a tag 206. The digital image application 110 can also associate additional tags 206 to associate other relevant information with the digital image 112, e.g., information derived from the digital image 112, the digital image captions 314, the digital image vectors 316, etc. According to some embodiments, the digital image application 110 can provide any of the aforementioned information inputs into at least one AL/ML model to cause the AL/ML model to output a descriptive phrase for the digital image 112. For example, in the example illustrated in FIG. 4A, the phrase “Jeff standing outside our office building” can be associated with the digital image 112-1 (by way of one or more tags 206), and the phrase “Jeff at dinner in San Francisco” can be associated with the digital image 112-2 (by way of one or more tags 206). In the example illustrated in FIG. 4B, the phrase “Katie outside our house wearing a blue dress” can be associated with the digital image 112 (by way of one or more tags 206). In the example illustrated in FIG. 4C, the phrase “Side view of Jon that resembles a mug shot” can be associated with the digital image 112 by way of one or more tags 206). It is noted that the foregoing examples are not meant to be limiting, and that any amount, type, form, etc., of information, at any level of granularity, can be associated with digital images 112 by way of tags 206 (or other associative procedures), consistent with the scope of this disclosure.

It should be appreciated that the user interfaces illustrated in FIG. 7 are merely exemplary and that they should not be construed as limiting. To the contrary, the digital image application 110 can be configured to output any amount, type, form, etc., of user interface(s), including any amount, type, form, etc., of information related to the messages 109, the digital images 112, the digital image captions 314, the tags 206, etc.—at any level of granularity—consistent with the scope of this disclosure.

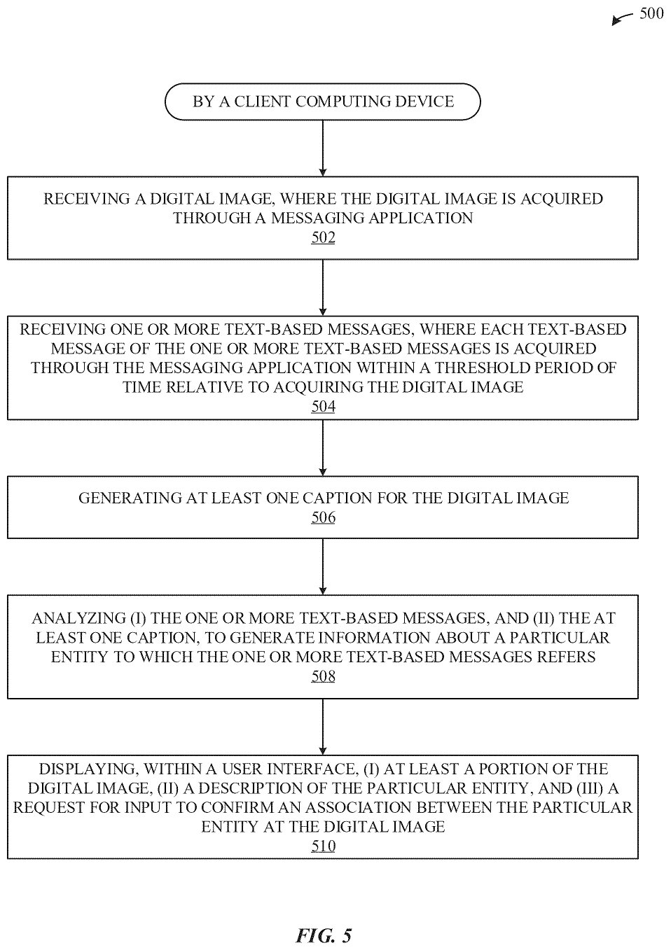

Accordingly, FIGS. 2, 3, and 4A-4C provide an understanding of how the messaging application 108 and the digital image application 110 can function, interact with one another, etc., to identify entities within digital images 112 using conversational information included in messages 109 associated with the digital images 112, according to some embodiments. Additionally, FIG. 5 illustrates a method 500 for identifying entities within digital images using conversational information associated with the digital images, according to some embodiments. As shown in FIG. 5, the method 500 begins at step 502, where the client computing device 102 receives a digital image, where the digital image is acquired through a messaging application (e.g., as described above in conjunction with FIGS. 1-4).

At step 504, the client computing device 102 receives one or more text-based messages, where each text-based message of the one or more text-based messages is acquired through the messaging application within a threshold period of time relative to acquiring the digital image (e.g., as described above in conjunction with FIGS. 1-4).

At step 506, the client computing device 102 generates at least one caption for the digital image (e.g., as described above in conjunction with FIGS. 1-4).

At step 508, the client computing device 102 analyzes (i) the one or more text-based messages, and (ii) the at least one caption, to generate information about a particular entity to which the one or more text-based messages refers (e.g., as described above in conjunction with FIGS. 1-4).

At step 510, the client computing device 102 displays, within a user interface, (i) at least a portion of the digital image, (ii) a description of the particular entity, and (iii) a request for input to confirm an association between the particular entity at the digital image (e.g., as described above in conjunction with FIGS. 1-4).

It should be appreciated that the various functionalities described herein that are implemented by the client computing device 102 can be configured as one or more Application Programming Interfaces (APIs) (e.g., on one or more partner computing devices 130) to effectively enable other entities (e.g., software developers, cloud service providers, etc.) to access, implement, etc., the various functionalities. For example, the APIs can enable a given software application to provide the functionalities described herein relative to data that is managed by the software application, data that is managed by other entities with which the software application communicates, and so on. In another example, the various functionalities can be implemented as a cloud service to enable other entities to access, implement, etc. the various functionalities. For example, the cloud service can enable a given entity to upload its data for processing so that queries can be issued against the data and query results can be obtained in accordance with the techniques described herein. It is noted that the foregoing examples are not meant to be limiting, and that the functionalities described herein can be provided, exposed to, etc., any number, type, form, etc., of entity, at any level of granularity, consistent with the scope of this disclosure.

FIG. 6 illustrates a detailed view of a computing device 600 that can be used to implement the various components described herein, according to some embodiments. In particular, the detailed view illustrates various components that can be included in the client computing device 102, the partner computing device 130, and so on, described above in conjunction with FIG. 1.

As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Furthermore, the computing device 600 can include a display 610 (screen display) that can be controlled by the processor 602 to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

The computing device 600 also includes a storage device 640, which can comprise a single disk or a plurality of disks (e.g., SSDs), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
receiving a digital image, wherein the digital image is acquired through a messaging application;
receiving one or more text-based messages, wherein the one or more text-based messages are acquired through the messaging application within a threshold period of time relative to acquiring the digital image;
generating at least one caption for the digital image;
analyzing the one or more text-based messages, and the at least one caption, to generate information about a particular entity to which the one or more text-based messages refer; and
displaying, within a user interface:
at least a portion of the digital image,
a description of the particular entity, and
a request for input to confirm an association between the particular entity at the digital image.

2. The method of claim 1, wherein analyzing the one or more text-based messages to identify the particular entity to which the one or more text-based messages refers includes providing the one or more text-based messages, and the at least one caption, to at least one large-language model that causes the large-language model to generate the information about the particular entity.

3. The method of claim 2, wherein at least one text-based message of the one or more text-based messages includes at least one first, second, or third person pronoun, at least one name, or some combination thereof.

4. The method of claim 1, further comprising:
providing the one or more text-based messages to at least one large-language model to generate second information about characteristics of the digital image;
generating third information based on the second information, the at least one caption, or some combination thereof; and
associating the third information with the digital image.

5. The method of claim 1, further comprising:
accessing an address book associated with a plurality of contacts, wherein each contact of the plurality of contacts is associated with a name, and optionally a respective digital image;
referencing the particular entity, the digital image, or some combination thereof, against the plurality of contacts to identify a particular contact that corresponds to the particular entity; and
associating the particular contact with the digital image.

6. The method of claim 1, further comprising:
identifying, among a plurality of digital images, at least one digital image that, like the digital image, includes the particular entity; and
displaying at least a portion of the at least one digital image in a manner that indicates the at least one digital image relates to the digital image.

7. The method of claim 1, wherein the particular entity represents a person, an animal, a place, or a thing.

8. The method of claim 1, further comprising:
receiving a confirmation of the association between the particular entity and the digital image; and
associating the information about the particular entity with the digital image.

9. A non-transitory computer readable storage medium configured to store instructions that, when executed by at least one processor included in a client computing device, cause the client computing device to perform steps that include:
receiving a digital image, wherein the digital image is acquired through a messaging application;
receiving one or more text-based messages, wherein each text-based message of the one or more text-based messages is acquired through the messaging application within a threshold period of time relative to acquiring the digital image;
generating at least one caption for the digital image;
analyzing the one or more text-based messages, and the at least one caption, to generate information about a particular entity to which the one or more text-based messages refer; and
displaying, within a user interface:
at least a portion of the digital image,
a description of the particular entity, and
a request for input to confirm an association between the particular entity at the digital image.

10. The non-transitory computer readable storage medium of claim 9, wherein analyzing the one or more text-based messages to identify the particular entity to which the one or more text-based messages refers includes providing the one or more text-based messages, and the at least one caption, to at least one large-language model that causes the large-language model to generate the information about the particular entity.

11. The non-transitory computer readable storage medium of claim 10, wherein at least one text-based message of the one or more text-based messages includes at least one first, second, or third person pronoun, at least one name, or some combination thereof.

12. The non-transitory computer readable storage medium of claim 9, wherein the steps further include:
providing the one or more text-based messages to at least one large-language model to generate second information about characteristics of the digital image;
generating third information based on the second information, the at least one caption, or some combination thereof; and
associating the third information with the digital image.

13. The non-transitory computer readable storage medium of claim 9, wherein the steps further include:
accessing an address book associated with a plurality of contacts, wherein each contact of the plurality of contacts is associated with a name, and optionally a respective digital image;
referencing the particular entity, the digital image, or some combination thereof, against the plurality of contacts to identify a particular contact that corresponds to the particular entity; and
associating the particular contact with the digital image.

14. The non-transitory computer readable storage medium of claim 9, wherein the steps further include:
identifying, among a plurality of digital images, at least one digital image that, like the digital image, includes the particular entity; and
displaying at least a portion of the at least one digital image in a manner that indicates the at least one digital image relates to the digital image.

15. The non-transitory computer readable storage medium of claim 9, wherein the particular entity represents a person, an animal, a place, or a thing.

16. The non-transitory computer readable storage medium of claim 9, wherein the steps further include:
receiving a confirmation of the association between the particular entity and the digital image; and
associating the information about the particular entity with the digital image.

17. A client computing device comprising:
at least one processor; and
at least one memory storing instructions that, when executed by the at least one processor, cause the client computing device to carry out steps that include:
receiving a digital image, wherein the digital image is acquired through a messaging application;
receiving one or more text-based messages, wherein each text-based message of the one or more text-based messages is acquired through the messaging application within a threshold period of time relative to acquiring the digital image;
generating at least one caption for the digital image;
analyzing the one or more text-based messages, and the at least one caption, to generate information about a particular entity to which the one or more text-based messages refer; and
displaying, within a user interface:
at least a portion of the digital image,
a description of the particular entity, and
a request for input to confirm an association between the particular entity at the digital image.

18. The client computing device of claim 17, wherein analyzing the one or more text-based messages to identify the particular entity to which the one or more text-based messages refers includes providing the one or more text-based messages, and the at least one caption, to at least one large-language model that causes the large-language model to generate the information about the particular entity.

19. The client computing device of claim 18, wherein at least one text-based message of the one or more text-based messages includes:
at least one first, second, or third person pronoun,
at least one name, or
some combination thereof.

20. The client computing device of claim 17, wherein the steps further include:
providing the one or more text-based messages to at least one large-language model to generate second information about characteristics of the digital image;
generating third information based on the second information, the at least one caption, or some combination thereof; and
associating the third information with the digital image.
